(19) United States
(12) Patent Application Publication
(10) Pub. No.: US 2011/0148995 A1
(43) Pub. Date: Jun. 23, 2011

(54) Inkjet print head, inkjet print head assembly and method of manufacturing inkjet print head assembly

(75) Inventors: Hwa Sun Lee, Hwaseong (KR); Seung Joo Shin, Seoul (KR); Seung Mo Lim, Suwon (KR); Jae Chang Lee, Hwaseong (KR); Tae Kyung Lee, Suwon (KR)

(73) Assignee: SAMSUNG ELECTRO-MECHANICS CO., LTD., Suwon (KR)

(21) Appl. No.: 12/923,097

(22) Filed: Sep. 1, 2010

(30) Foreign Application Priority Data
Dec. 17, 2009 (KR) 10-2009-0126065

(51) Int. Cl. B41J 2/045

(52) U.S. Cl. 347/71

(57) ABSTRACT

There is provided an inkjet print head including: a head plate having nozzles arranged in a length direction, in which each of the nozzles ejects ink therethrough from a side surface of the head plate; an ink inlet provided in the lower portion of the head plate and drawing ink therethrough; a pressure chamber storing the ink drawn in through the ink inlet and communicating with the nozzle; and a piezoelectric element supplying the pressure chamber with driving force in a direction perpendicular to a direction of the ink ejected through the nozzle communicating with the pressure chamber and disposed on the pressure chamber having a membrane interposed therebetween.

### CROSS-REFERENCE TO RELATED APPLICATIONS

This application claims the priority of Korean Patent Application No. 10-2009-0126065 filed on Dec. 17, 2009, in the Korean Intellectual Property Office, the disclosure of which is incorporated herein by reference.

### BACKGROUND OF THE INVENTION

1. Field of the Invention

The present invention relates to an inkjet print head, an inkjet print head assembly, and a method of manufacturing the inkjet print head assembly, capable of simplifying a flow path inside a side-ejecting type inkjet print head that ejects ink from the side surface thereof and facilitating the packaging of a cartridge head that supplies ink to the inkjet print head.

2. Description of the Related Art

In general, an inkjet print head converts electrical signals into physical impulses so that ink droplets are ejected through small nozzles. Particularly, an inkjet head assembly includes an inkjet head having a nozzle plate and a cartridge supplying ink to the inkjet head.

In recent years, a piezoelectric inkjet head has been used in industrial inkjet printers. For example, it is used to directly form a circuit pattern by spraying ink prepared by melting metals such as gold or silver onto a printed circuit board (PCB). A piezoelectric inkjet head is also used for creating industrial graphics, or for the manufacturing of a liquid crystal display (LCD), an organic light emitting diode (OLED), and a solar cell.

Inside an inkjet print head of an industrial inkjet printer, there are provided an inlet through which ink is drawn, a reservoir storing the ink being drawn, and a pressure chamber transferring the driving force of a piezoelectric element so as to move the ink stored in the reservoir toward a nozzle.

A conventional inkjet print head has a complex flow structure. Specifically, the inkjet print head has an inlet formed in the upper portion thereof. Ink drawn from the upper inlet is stored in a reservoir that is formed in the lower portion of the inkjet print head. After that, the ink moves upward into a pressure chamber.

Also, a piezoelectric element and the inlet are formed to be on the same plane of the conventional inkjet print head, thereby having a complex wiring system. Further, when combined with a cartridge, the inkjet print head has a problem with packaging.

### SUMMARY OF THE INVENTION

An aspect of the present invention provides an inkjet print head, an inkjet print head assembly, and a method of manufacturing the inkjet print head assembly, capable of simplifying a flow path inside a side-ejecting type inkjet print head that ejects ink from the side surface thereof and facilitating the packaging of a cartridge head that supplies ink to the inkjet print head.

According to an aspect of the present invention, there is provided an inkjet print head including: a head plate having nozzles arranged in a length direction, in which each of the nozzles ejects ink therethrough from a side surface of the head plate; an ink inlet provided in the lower portion of the head plate and drawing ink therethrough; a pressure chamber storing the ink drawn in through the ink inlet and communicating with the nozzle; and a piezoelectric element supplying the pressure chamber with driving force in a direction perpendicular to a direction of the ink ejected through the nozzle communicating with the pressure chamber and disposed on the pressure chamber having a membrane interposed therebetween.

The inkjet print head may further include a restrictor provided between the pressure chamber and the ink inlet and preventing the ink of the pressure chamber from flowing backward into the ink inlet.

The restrictor may include a plurality of micro holes.

The head plate may include two silicon substrates. The pressure chamber may be provided in an upper substrate and the nozzle and the ink inlet may be provided in a lower substrate.

The upper substrate may be a silicon on insulator (SOI) substrate.

According to another aspect of the present invention, there is provided an inkjet print head assembly including: a lower substrate having an ink inlet and a restrictor provided in a height direction and having a nozzle in a width direction; an upper substrate having a pressure chamber provided therein, the pressure chamber storing ink drawn in through the ink inlet and communicating with the nozzle; a piezoelectric element provided on a membrane of the upper substrate and supplying the pressure chamber with driving force; and a cartridge head coupled with the lower substrate and having a manifold storing ink so as to supply the ink to the ink inlet.

The cartridge head may include a through-hole in order to draw the ink from the outside.

The restrictor may include a plurality of micro holes.

The upper substrate may be a silicon on insulator (SOI) substrate.

The cartridge head may be formed of metal.

According to another aspect of the present invention, there is provided a method of manufacturing an inkjet print head assembly, the method including: forming a groove for a pressure chamber by etching an upper substrate; etching a plurality of micro holes for a restrictor at a position corresponding to a portion of the pressure chamber in a lower substrate, etching a groove for a nozzle from a side edge of an upper portion of the lower substrate to a position corresponding to another portion of the pressure chamber, and etching an ink inlet communicating with the micro holes and exposed at a lower portion of the lower substrate; coupling the upper substrate with the lower substrate such that the pressure chamber is allowed to communicate with the nozzle and the restrictor; and coupling the lower substrate with a cartridge head having a manifold formed therein such that the ink inlet of the lower substrate is allowed to communicate with the manifold storing externally supplied ink.

The upper substrate may be a silicon on insulator (SOI) substrate.

The cartridge head may be formed of metal.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view schematically illustrating an inkjet print head assembly according to an exemplary embodiment of the present invention;

FIG. 2 is a schematic perspective view illustrating an inkjet print head according to an exemplary embodiment of the present invention;

FIG. 3 is a cross-sectional view taken along a line III-III shown in FIG. 2;

FIG. 4 is a cross-sectional view schematically illustrating an inkjet print head assembly according to an exemplary embodiment of the present invention; and

FIGS. 5A through 5E are cross-sectional views schematically illustrating a method of manufacturing an inkjet print head assembly according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the same reference numerals will be used throughout to designate the same or like components.

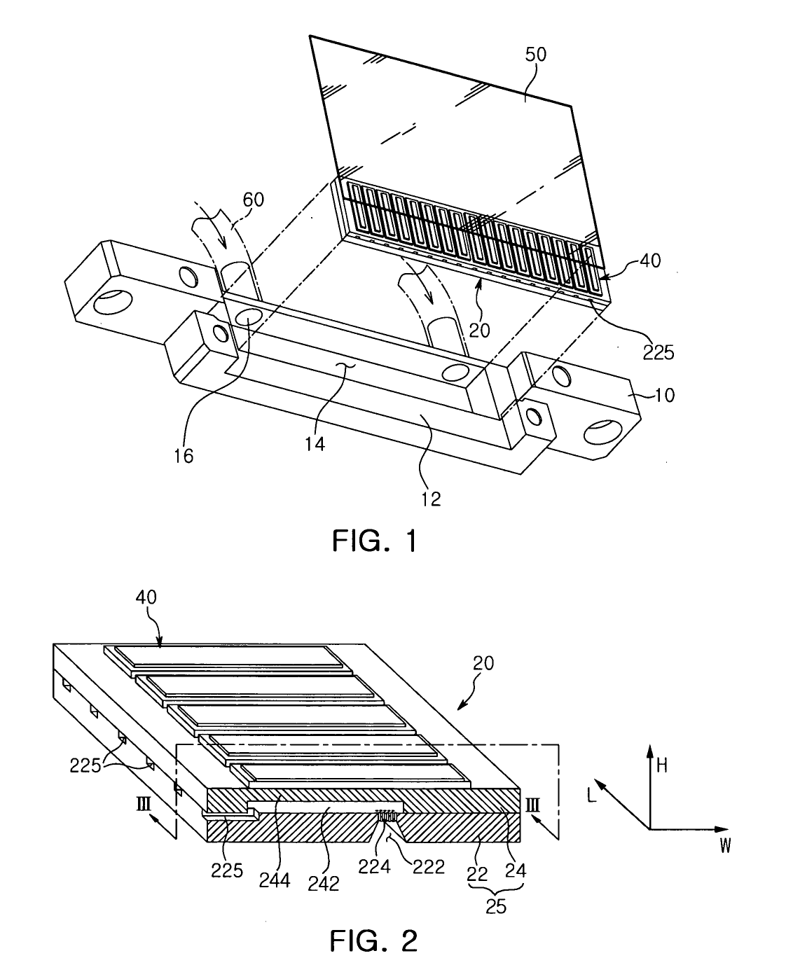

FIG. 1 is an exploded perspective view schematically illustrating an inkjet print head assembly according to an exemplary embodiment of the present invention.

Referring to FIG. 1, an inkjet print head assembly 1 according to an exemplary embodiment of the invention may include an inkjet print head 20, a piezoelectric element 40, and a cartridge head 10.

The inkjet print head 20 is formed of a rectangular parallelepiped head plate 25. The head plate 25 has a flow path structure allowing ink drawn from the cartridge head 10 to be ejected to the outside.

According to this embodiment, ink is drawn through an ink inlet 222 formed in the lower portion of the head plate 25 and is ejected to the outside through the side surface of the head plate 25.

The piezoelectric element 40 may provide driving force for ejecting the ink inside the head plate 25 to the outside. The piezoelectric element 40 may be coupled with a flexible printed circuit board (FPCB) 50 for external power supply.

The cartridge head 10 has a mounting part 12 on which the inkjet print head 20 is mounted. Inside the mounting part 12, a manifold 14 with which to store externally supplied ink is formed.

The cartridge head 10 according to this embodiment receives the externally supplied ink through a tube 60. Here, the tube 60 may communicate with a through-hole 16 formed in the manifold 14.

Although not shown, the cartridge head 10 may receive ink from a cartridge that is a storage tank of ink.

The inkjet print head 20 applied to the inkjet print head assembly 1 may include all technical features of the inkjet print head 20 according to exemplary embodiments of FIGS. 2 through 5 described below.

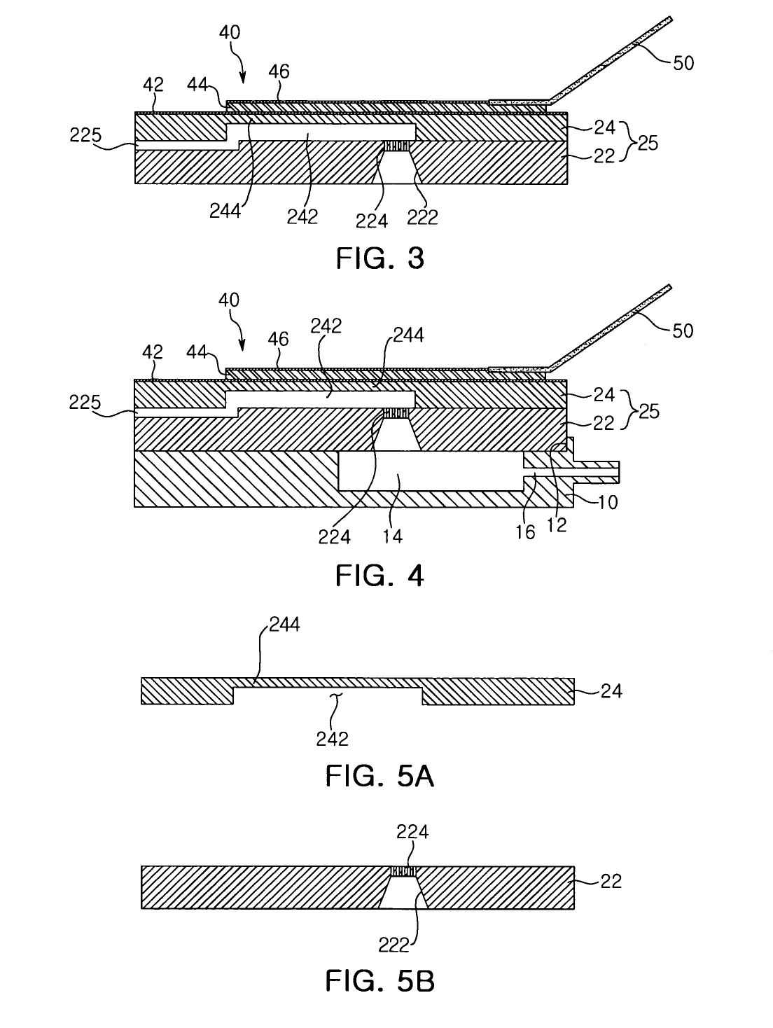

FIG. 2 is a perspective view schematically illustrating an inkjet print head according to an exemplary embodiment of the present invention. FIG. 3 is a cross-sectional view taken along a line III-III shown in FIG. 2. FIG. 4 is a cross-sectional view schematically illustrating an inkjet print head assembly according to an exemplary embodiment of the present invention.

Referring to FIGS. 2 through 4, the inkjet print head 20 may include the head plate 25, the flow path structure formed inside the head plate 25, and the piezoelectric element 40.

The head plate 25 may be formed by stacking a plurality of silicon substrates and have a rectangular parallelepiped shape. In this embodiment, a lower substrate 22 and an upper substrate 24 may be stacked to form the head plate 25.

Here, directions set forth herein are defined below. A height direction H defines a direction stacked from the lower substrate 22 to the upper substrate 24. A width direction W defines a direction in which ink flows inside the inkjet print head 20. A length direction L defines a direction in which nozzles are arranged in rows inside the inkjet print head 20.

The inkjet print head 20 according to this embodiment may have nozzles 225 arranged in rows in the length direction L. The nozzle 225 ejects ink from the side surface of the head plate 25. The ink inlet 222 may be formed in the lower portion of the head plate 25. The ink drawn through the ink inlet 222 is transferred to a pressure chamber 242 and is stored in the pressure chamber 242. After that, the ink is ejected to the outside through the nozzle 225 by the driving force of the piezoelectric element 40.

Specifically, the upper substrate 24 may have the pressure chamber 242 formed therein. The pressure chamber 242 stores the ink drawn in through the ink inlet 222 and communicates with the nozzle 225 so as to eject the ink. In order to exactly set the height of the pressure chamber 242, the upper substrate 24 may employ a silicon on insulator (SOI) substrate having an intermediate oxide film that acts as an etch stop layer.

Also, the lower substrate 22 may have a restrictor 224 formed therein. The restrictor 224 is formed above the ink inlet 222 in order to prevent the ink of the pressure chamber 242 from flowing backward into the ink inlet 222. The restrictor 224 may include a plurality of micro holes and act as an ink filter.

The piezoelectric element 40 may be provided on a membrane 244 of the upper substrate 24. The piezoelectric element 40 may supply the pressure chamber 242 with the driving force for ink ejection.

The piezoelectric element 40 may allow for ink ejection by transforming the membrane 244 that is the upper surface of the pressure chamber 242. A piezoelectric element may convert electrical energy into mechanical energy or vice versa, and its representative material is Pb (Zr, Ti) O₃. Also, for the ink ejection, a bubble jet or thermal jet method, besides a piezoelectric method using the piezoelectric element 40, may be used.

The piezoelectric element 40 may include a lower electrode 42 acting as a common electrode, a piezoelectric portion 44 being transformed according to the application of voltage, and an upper electrode 46 acting as a driving electrode applying voltage to the piezoelectric portion 44.

When the voltage is applied to the piezoelectric portion 44, the driving force is transferred within the pressure chamber 242 in a vertical direction by upward and downward distortions of the membrane 244. Here, the driving force may allow the ink inside the pressure chamber 242 to be ejected to the outside through the nozzle 225.

The nozzle 225 is formed in the width direction toward the side surface of the head plate 25. Accordingly, the ink is ejected in a direction perpendicular to the direction in which the driving force is transferred within the pressure chamber 242.

When the ink is ejected in the direction perpendicular to the transferal direction of the driving force within the pressure chamber 242, cross-talk that is interference between the nozzles may be reduced.

Since the ink inlet 222 is formed in the lower substrate 22 in such a manner that the ink inlet 222 is opposed to the piezoelectric element 40, packaging with the cartridge head 10 is facilitated, as shown in FIG. 4.

The cartridge head 10 is coupled with the lower part of the lower substrate 22. Here, the manifold 14 inside the cartridge head 10 communicates with the ink inlet 222.

The cartridge head 10 may be formed of metal unlike the material of the inkjet print head 20, thereby increasing corrosion resistance with respect to ink storage.

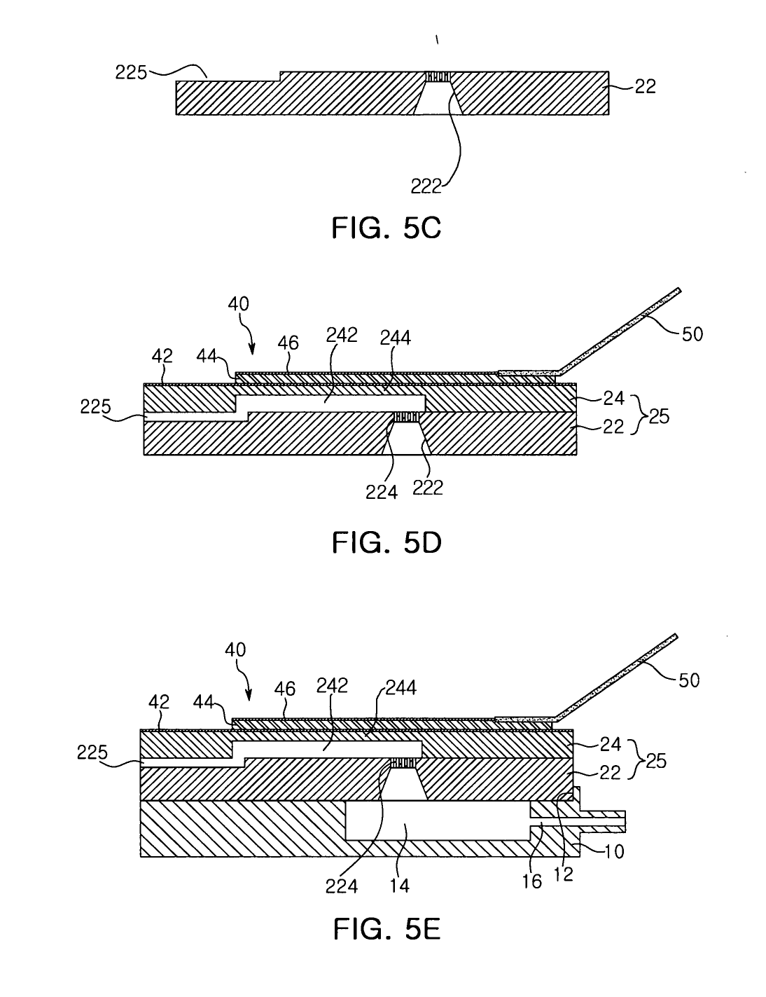

FIGS. 5A through 5E are cross-sectional views schematically illustrating a method of manufacturing an inkjet print head assembly according to an exemplary embodiment of the present invention.

FIG. 5A shows forming a groove for the pressure chamber 242 by etching the upper substrate 24 that is an SOI substrate. Since the SOI substrate has an intermediate oxide film formed therein and the intermediate oxide film, when etched, acts as an etch stop layer, the height of the pressure chamber 242 may be exactly set.

FIGS. 5B and 5C show forming a flow path structure in the lower substrate 22. The lower substrate 22 may be divided into a layer for the ink inlet 222 and a layer for the restrictor 224 and the nozzle 225 using the SOI substrate.

The order of the forming processes of the upper and lower substrates 24 and 22 is not particularly limited.

The restrictor 224 may be formed by etching a plurality of micro holes in a position corresponding to a portion of the pressure chamber 242 in the lower substrate 22.

The ink inlet 222 is etched in the height direction from the bottom surface of the lower substrate 22 so that the ink inlet 222 communicates with the plurality of micro holes.

The nozzle 225 may be formed by a groove which is etched from a side edge of the upper portion of the lower substrate 22 to a position corresponding to another portion of the pressure chamber 242.

The coupling process of the micro-fabricated upper and lower substrates 24 and 22 is shown in FIG. 5D. Due to this coupling process, a flow path including the ink inlet 222, the restrictor 224, the pressure chamber 242 and the nozzle 225 is thereby created.

FIG. 5E shows that the lower substrate 22 is coupled with the cartridge head 10.

The cartridge head 10 having the manifold 14 storing externally supplied ink and the lower substrate 22 having the ink inlet 222 are coupled with each other in order that the manifold 14 may communicate with the ink inlet 222, thereby forming the inkjet print head assembly 1.

In the inkjet print head, the inkjet print head assembly and the method of manufacturing the inkjet print head assembly according to the present invention, a simple flow path structure is constructed such that ink is drawn from the lower part of the inkjet print head and is ejected from the side surface thereof.

Due to the simple flow path structure in the inkjet print head, the manufacturing process thereof may be simplified. Since the ink is ejected from the side surface of the inkjet print head such that the direction of the ejected ink is perpendicular to the transferal direction of the driving force of the piezoelectric element, cross-talk between the nozzles may be alleviated.

Furthermore, since the ink inlet is provided to be opposed to the piezoelectric element and packaging is made with the lower surface of the inkjet print head, a wiring structure may be easily exposed to the outside and the packaging of the inkjet print head may be automated.

As set forth above, according to exemplary embodiments of the invention, the inkjet print head has a simple flow path structure in which ink is drawn from the lower part of the inkjet print head and is ejected from the side surface thereof.

Since the inkjet print head has the simple flow path structure, the manufacturing process thereof is simplified. Since the ink is ejected from the side surface of the inkjet print head, the direction of the ejected ink is perpendicular to the transferal direction of the driving force of the piezoelectric element, whereby the cross-talk is alleviated.

In addition, the ink inlet is formed to be opposed to the piezoelectric element and packaging is made with the lower surface of the inkjet print head, so it is easy to expose the wiring structure to the outside and automate the packaging of the inkjet print head.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet print head comprising:
a head plate having nozzles arranged in a length direction, each of the nozzles ejecting ink therethrough from a side surface of the head plate;
an ink inlet provided in the lower portion of the head plate and drawing ink therethrough;
a pressure chamber storing the ink drawn in through the ink inlet and communicating with the nozzle; and
a piezoelectric element supplying the pressure chamber with driving force in a direction perpendicular to a direction of the ink ejected through the nozzle communicating with the pressure chamber and disposed on the pressure chamber having a membrane interposed therebetween.

2. The inkjet print head of claim 1, further comprising a restrictor provided between the pressure chamber and the ink inlet and preventing the ink of the pressure chamber from flowing backward into the ink inlet.

3. The inkjet print head of claim 2, wherein the restrictor includes a plurality of micro holes.

4. The inkjet print head of claim 1, wherein the head plate includes two silicon substrates, and
the pressure chamber is provided in an upper substrate and the nozzle and the ink inlet are provided in a lower substrate.

5. The inkjet print head of claim 4, wherein the upper substrate is a silicon on insulator (SOI) substrate.

6. An inkjet print head assembly comprising:
a lower substrate having an ink inlet and a restrictor provided in a height direction and having a nozzle in a width direction;
an upper substrate having a pressure chamber provided therein, the pressure chamber storing ink drawn in through the ink inlet and communicating with the nozzle;
a piezoelectric element provided on a membrane of the upper substrate and supplying the pressure chamber with driving force; and
a cartridge head coupled with the lower substrate and having a manifold storing ink so as to supply the ink to the ink inlet.

7. The inkjet print head assembly of claim 6, wherein the cartridge head includes a through-hole in order to draw the ink from the outside.

8. The inkjet print head assembly of claim 6, wherein the restrictor includes a plurality of micro holes.

9. The inkjet print head assembly of claim 6, wherein the upper substrate is a silicon on insulator (SOI) substrate.

10. The inkjet print head assembly of claim 6, wherein the cartridge head is formed of metal.

11. A method of manufacturing an inkjet print head assembly, the method comprising:
forming a groove for a pressure chamber by etching an upper substrate;
etching a plurality of micro holes for a restrictor at a position corresponding to a portion of the pressure chamber in a lower substrate, etching a groove for a nozzle from a side edge of an upper portion of the lower substrate to a position corresponding to another portion of the pressure chamber, and etching an ink inlet communicating with the micro holes and exposed at a lower portion of the lower substrate;
coupling the upper substrate with the lower substrate such that the pressure chamber is allowed to communicate with the nozzle and the restrictor; and
coupling the lower substrate with a cartridge head having a manifold formed therein such that the ink inlet of the lower substrate is allowed to communicate with the manifold storing externally supplied ink.

12. The method of claim 11, wherein the upper substrate is a silicon on insulator (SOI) substrate.

13. The method of claim 11, wherein the cartridge head is formed of metal.
